(19) United States
(12) Patent Application Publication
(10) Pub. No.: US 2026/0105627 A1
(43) Pub. Date: Apr. 16, 2026

(54) INPUT SUPPORT SYSTEM, INPUT SUPPORT METHOD, AND NON-TRANSITORY COMPUTER READABLE MEDIUM

(71) Applicant: NEC Corporation, Minato-ku, Tokyo (JP)

(72) Inventor: Akira TSUCHIYA, Tokyo (JP)

(73) Assignee: NEC Corporation, Minato-ku, Tokyo (JP)

(21) Appl. No.: 19/114,547

(22) PCT Filed: Oct. 28, 2022
(86) PCT No.: PCT/JP2022/040318

§ 371 Date: Mar. 24, 2025

(51) Int. Cl. G06T 7/73; G06T 5/50; G06V 10/25

(52) U.S. Cl. CPC G06T 7/73; G06T 5/50; G06V 10/25; G06T 2207/20221

(57) ABSTRACT

An input support system (100) includes: calculation unit (110) for calculating a position related to a feature point from an input image; display control unit (140) for displaying the input image and a pointer operated by a user on a screen; receiving unit (120) for receiving a first input from the user; and specifying unit (130) for specifying a first position based on the position related to the feature point calculated by the calculation unit (110), in which the display control unit (140) moves the pointer to the first position in response to receiving the first input.

### TECHNICAL FIELD

The present disclosure relates to an input support system, an input support method, and a program, and in particular, to an input support system, an input support method, and a program for reducing the workload of inputting work performed by a user.

### BACKGROUND ART

A method in which after feature points are detected from an image obtained by photographing a detection target through image processing, a user can check the result of the detection and, when necessary, can perform a correction process has been commonly known (Patent Literature 1 and the like).

### CITATION LIST

### Patent Literature

Patent Literature 1: Japanese Unexamined Patent Application Publication No. 2019-57111

### SUMMARY OF INVENTION

### Technical Problem

However, the above-described background art has a problem that the workload is large because the user needs to manually move a pointer.

Therefore, one of the objects to be achieved by an example embodiment disclosed in this specification is to provide an input support system, an input support method, and a program capable of reducing the workload of a pointer moving operation.

### Solution to Problem

An input support system according to a first aspect of this disclosure includes:
calculation means for calculating a position related to a feature point from an input image;
display control means for displaying the input image and a pointer operated by a user on a screen;
receiving means for receiving a first input from the user; and
specifying means for specifying a first position based on the position related to the feature point calculated by the calculation means, in which
the display control means moves the pointer to the first position in response to receiving the first input.

In an input support method according to a second aspect of this disclosure, a computer:
calculates a position related to a feature point from an input image;
displays the input image and a pointer operated by a user on a screen;
receives a first input from the user;
specifies a first position based on the calculated position related to the feature point; and
moves the pointer to the first position in response to receiving the first input.

A program according to a third aspect of this disclosure causes a computer to perform:
a calculation step of calculating a position related to a feature point from an input image;
a display control step of displaying the input image and a pointer operated by a user on a screen;
a receiving step of receiving a first input from the user; and
a specifying step of specifying a first position based on the position related to the feature point calculated in the calculation step, in which
in the display control step, the pointer is moved to the first position in response to receiving the first input.

### BRIEF DESCRIPTION OF DRAWINGS

FIG. 1 is a block diagram showing an example of a configuration of an input support system according to a first example embodiment;

FIG. 2 is a flowchart showing an example of operations performed by the input support system according to the first example embodiment;

FIG. 3 is a block diagram showing an example of a configuration of an input support system according to a second example embodiment;

FIG. 4 shows an example of an image displayed on a screen by the input support system according to the second example embodiment, and in particular, shows an example of an input image and calculated feature points;

FIG. 5 is a flowchart showing an example of operations performed by the input support system according to the second example embodiment;

FIG. 6 shows a hardware configuration of the input support system according to the second example embodiment;

FIG. 7 is a block diagram showing an example of a configuration of an input support system according to a third example embodiment;

FIG. 8 shows an example of an image displayed on a screen by the input support system according to the third example embodiment, and in particular, shows an example of a movement of a pointer;

FIG. 9 is a flowchart showing an example of operations performed by the input support system according to the third example embodiment;

FIG. 10 is a block diagram showing an example configuration of an input support system according to a fourth example embodiment;

FIG. 11 shows an example of an image displayed on a screen by the input support system according to the fourth example embodiment, and in particular, shows an example of an input image and a calculated bounding box;

FIG. 12 shows an example of an image displayed on a screen by the input support system according to the fourth example embodiment, and in particular, shows an example of a movement of a pointer;

FIG. 13 is a flowchart showing an example of operations performed by the input support system according to the fourth example embodiment;

FIG. 14 shows an example of an image displayed on a screen by the input support system according to the fourth example embodiment, and in particular, shows an example of a displayed bounding box;

FIG. 15 is a block diagram showing an example configuration of an input support system according to a fifth example embodiment;

FIG. 16 is a flowchart showing an example of operations performed by the input support system according to the fifth example embodiment;

FIG. 17 is a block diagram showing an example configuration of an input support system according to a sixth example embodiment;

FIG. 18 is a flowchart showing an example of operations performed by the input support system according to the sixth example embodiment;

FIG. 19 is a block diagram showing an example of a configuration of an input support system according to a seventh example embodiment;

FIG. 20 shows an example of an image displayed on a screen by the input support system according to the seventh example embodiment, and in particular, shows an example of a sense-of-visual area; and

FIG. 21 is a flowchart showing an example of operations performed by the input support system according to the seventh example embodiment.

### EXAMPLE EMBODIMENT

An input support system according to an example embodiment described hereinafter is a system that assists a user (human being), who watches an input image, to determine the position of a feature point or the position of a bounding box in this input image. Therefore, a position calculated by a calculation unit of the input support system is used to assist the user to input a position or the like, and hence the position calculated by the calculation unit is not immediately adopted as the position of a feature point or the position of a bounding box in the input image.

### First Example Embodiment

Firstly, a first example embodiment will be described.

### Explanation of Configuration

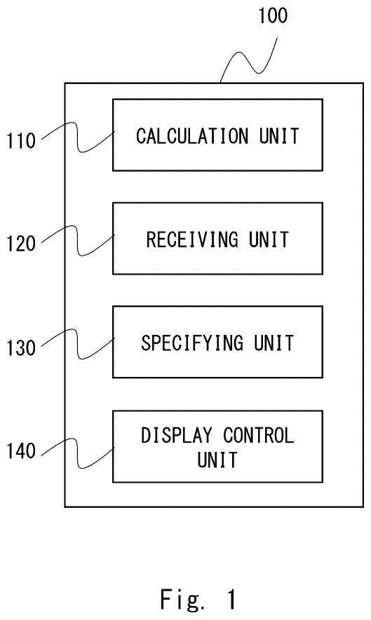

FIG. 1 is a block diagram showing an example of a configuration of an input support system according to a first example embodiment. As shown in FIG. 1, the input support system 100 includes a calculation unit 110, a receiving unit 120, a specifying unit 130, and a display control unit 140.

The calculation unit 110 calculates a position related to a feature point from an input image. Specifically, the position related to a feature point means the position of a feature point or a position of a bounding box surrounding feature points constituting an object. The receiving unit 120 receives a first input from a user. The first input is a predetermined input that signals the start of an operation that the user performs for a new designation related to a feature point. This first input may also be referred to as a designation start input. Note that in other example embodiments described later, the first input also refers to the input described here. Specifically, the first input is, for example, an operation for designating the position of a (immediately preceding) feature point or an operation for moving the pointer to a feature point that the user wants to designate. Further, the pointer is a mark displayed on the screen for the user to designate a feature point. The specifying unit 130 specifies the first position based on the position related to the feature point calculated by the calculation unit 110. The first position is a calculated position related to a feature point or a position near a calculated position related to a feature point (i.e., a position a predetermined distance away from a calculated position related to a feature point). Note that in other example embodiments described later, the first position also refers to the position described here. Specifically, the first position is, for example, a position of a feature point or a vertex of a bounding box, or a position near such a position. The display control unit 140 displays a pointer operated by the user and an input image on the screen. Then, when the receiving unit 120 receives the first input, the display control unit 140 moves the pointer to the first position specified by the specifying unit 130.

### Explanation of Operation

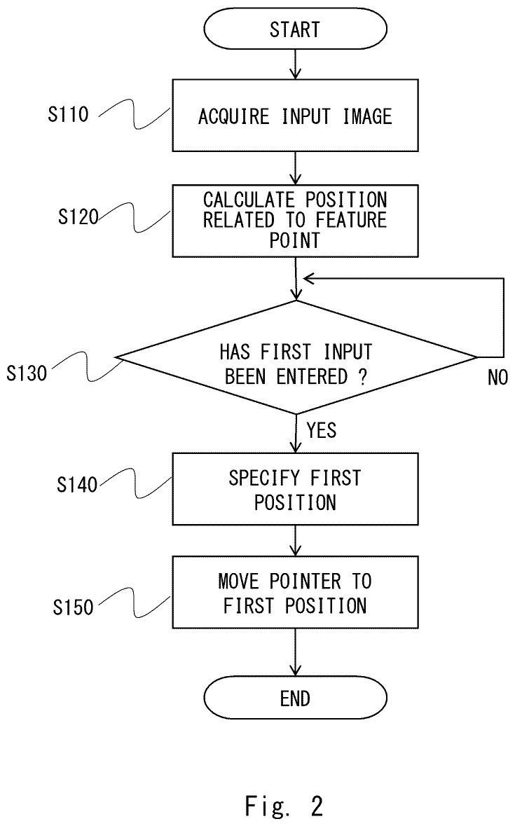

FIG. 2 is a flowchart showing operations performed by the input support system 100 in the first example embodiment. A series of processes performed by the input support system 100 will be described with reference to FIG. 2.

The calculation unit 110 acquires an input image (Step S110). The calculation unit 110 calculates a position related to a feature point from the acquired input image (Step S120). The receiving unit 120 determines whether or not a first input has been received from a user (Step S130). When the first input is received, the process proceeds to a step S140. When this is not the case, the process in the step S130 is repeated. When the receiving unit 120 receives the first input, the specifying unit 130 specifies a first position based on the position related to the feature point calculated in the step S120 (Step S140). Then, the display control unit 140 controls the display so that the position of the pointer moves to the first position specified by the specifying unit 130 (Step S150).

Note that the timing at which the step S140 is performed is not limited to this example, and instead may be any timing after the position related to the feature point is calculated in the step S120 and before the process for moving the pointer to the first position is performed in the step S150. For example, it is possible to perform the process for specifying the first position in advance by specifying the first position in the step S140 before the first input is received in the step S130. Therefore, the step S150 is performed next to the step S130, so that the user can move the pointer more intuitively.

### Explanation of Effect

In the input support system 100 in the first example embodiment, the position related to the feature point in the input image is calculated by the calculation unit 110, and as the first input is entered by the user, the display control unit 140 moves the pointer to the first position specified by the specifying unit 130. The user of this input support system 100 can move the pointer to the first position, which is, for example, near the feature point that he/she intends to designate, by simply entering a predetermined first input. In this way, in the input support system 100, it is possible to move the pointer to the first position, which is, for example, near the feature point, without having the user move the pointer thereto. As a result, the input support system 100 can reduce the workload of the work for inputting feature points performed by the user, in particular, the workload of the moving operation during the inputting work.

### Second Example Embodiment

Next, a second example embodiment will be described.

### Explanation of Configuration

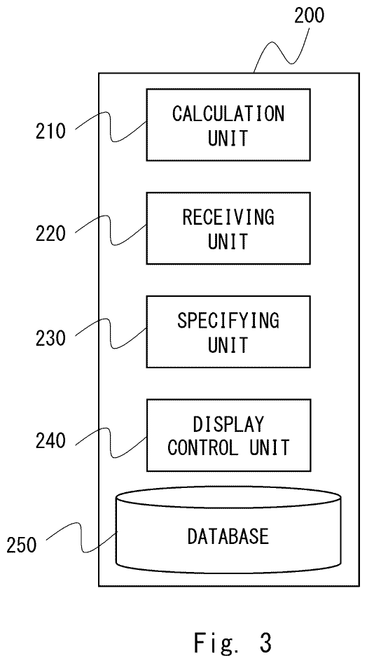

FIG. 3 is a block diagram showing an example of a configuration of an input support system according to the second example embodiment. As shown in FIG. 3, the input support system 200 includes a calculation unit 210, a receiving unit 220, a specifying unit 230, a display control unit 240, and a database 250.

The calculation unit 210 calculates a feature point from an input image. For example, when a face image is input to the input support system 200 as an input image in order to make a user designate positions of feature points on the face in the face image, the calculation unit 210 calculates features on the surface of the human face as feature points. Note that the features on the surface of the human face are, for example, features visible on the surface of the skin, such as eyes, a nose, a mouth, ears, eyebrows, a contour, moles, freckles, tattoos, bruises, wrinkles, dimples, wounds, warts, bumps, projections and depressions on the skin, and discolored parts on the skin. Further, the method for calculating a feature point is not limited to any particular methods. For example, a feature extraction technology such as SIFT (Scale Invariant Feature Transform) and KAZE may be used, or feature points may be extracted by using a machine learning model trained in advance. Note that although the face image has been described above as an example of the input image, the present disclosure may be applied to other types of images. For example, for object detection, an image acquired from a camera may be input, and feature points of an automobile shown in the image may be calculated. Alternatively, cracks in road conditions or utility holes may be calculated as feature points. Further, the feature points that the user wants to designate and the input image can be changed as desired. In this example embodiment, an example embodiment in which a face image is used as an input image will be described.

The receiving unit 220 receives a first input (designation start input) from the user. The receiving unit 220 receives a first input from the user through, for example, an input interface such as an input device 202 (which will be described later).

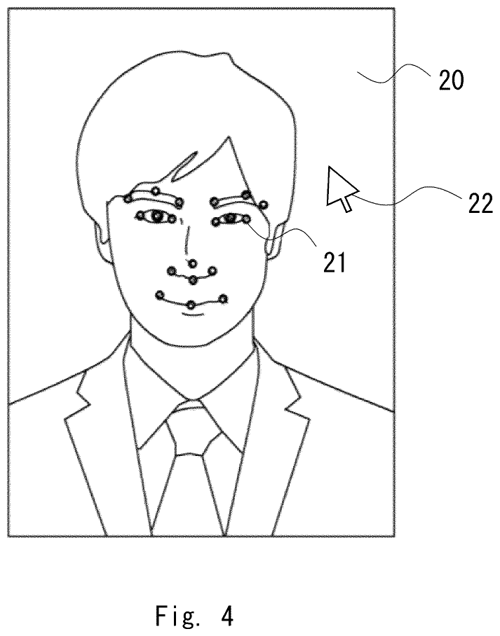

The specifying unit 230 specifies a first position based on the feature point calculated by the calculation unit 210. Specifically, in this example embodiment, the specifying unit 230 specifies, as the first position, the position of the feature point or a position near the feature point. For example, when there is a feature point 21 calculated from the input image 20 by the calculation unit 210 as shown in FIG. 4, the first position is the position of the feature point 21. Further, the first position may be a position a predetermined distance away from the position of the feature point. In this way, when the pointer 22 is moved to the first position under the control of the display control unit 240 (which will be described later), it is possible to prevent the moved pointer 22 from overlapping the feature point. Note that the aforementioned predetermined distance between the first position related to a certain feature point a and the position of this feature point a may be set to a distance shorter than distances between the first position related the feature point a and the positions of feature points other than the feature point a. The predetermined distance, i.e., the distance between the first position and the feature point, is preferably set to several pixels. In this way, since the pointer 22, which has been moved to the first position, and the feature point do not overlap each other in the display, the user can perform an operation in a better visibility state.

Note that the specifying unit 230 may determine, from among a plurality of feature points 21 calculated by the calculation unit 210, a feature point of which the user is about to designate the position, and specify the first position of the determined feature point. As a result, the pointer is automatically moved to a position which is desirable for the user, so that the usability for the user is further improved. For example, the specifying unit 230 may determine a feature point closest to the position of the pointer at the time when the first input is received as the feature point of which the user about to designate the position. That is, the specifying unit 230 may specify the first position based on the position of the pointer and the position related to the feature point. Further, the specifying unit 230 may compare data recording the position of a feature point already input by the user with the position of the feature point calculated by the calculation unit 210, and may determine, among the plurality of calculated feature points 21, a feature point located at a position the difference of which from the position of the feature point already input by the user is equal to or larger than a predetermined value as the feature point of which the user about to specify the position. That is, the specifying unit 230 may determine, among the feature points of which the positions have already been calculated by the calculation unit 210, a feature point of which the position has not yet been designated by the user in an area within a predetermined distance from the feature point as the feature point of which the user about to specify the position. In this regard, the specifying unit 230 may search for a point that is designated by the user and is closest to the feature point, and determine that the user has designated that feature point when the distance between these two points is equal to or shorter than a predetermined distance. By the above-described process, it is possible to specify a feature point of which the designation has not yet been made by the user, and specify the first position for such a feature point. As another example, the specifying unit 230 may calculate an estimated value (which will be described later) for each feature point calculated for the input image, which is the current processing target, based on history data of processes performed for input images input in the past, and may determine only a feature point of which the estimated value is equal to or higher than a predetermined value as a feature point of which the user about to specify the position. Further, for a feature point of which the estimated value is lower than the predetermined value, the position of a feature point calculated by the calculation unit 210 may be adopted as it is as the position of the feature point in the input image without making the designation of the position by the user. Note that the above-described history data is data recording, for each feature point in input images input in the past, the distance between the calculated position of the feature point and the position designated for this feature point by the user (i.e., the difference between these two positions). That is, the history data is data recording, for each feature point, the magnitude of the deviation between the position of the feature point calculated by the calculation unit 210 and the position of the feature point designated by the user is recorded. Further, the estimated value is a value obtained by estimating the distance between the position of the feature point calculated for the input image, which is the current processing object, and the position designated by the user (i.e., the difference between these two positions). That is, the estimated value is a value obtained by estimating the magnitude of the deviation between the position of the feature point calculated by the calculation unit 210 and the position of the feature point designated by the user. The estimated value may be calculated, for example, as follows. By using history data for a plurality of input images input in the past, an average value of distances between calculated positions of feature points and positions designated by the user may be calculated for each feature point, and this average value may be used as the estimated value. Further, the estimated value may be obtained by performing machine learning by using history data as training data. For example, when there are many cases in the past in each of which the position of a feature point at the outer corner of an eye among the positions of feature points on the face calculated by the calculation unit 210 is significantly corrected by the user, the above-described estimated value for the feature point at the outer corner of the eye exceeds the above-described predetermined value (i.e., the threshold). As described above, the specifying unit 230 calculates, for each of the feature points of which the positions are calculated by the calculation unit 210, the estimated value of the difference between the position calculated by the calculation unit 210 and the position designated by the user, and among the feature points of which the positions are calculated by the calculation unit 210, the feature point of which the estimated value is equal to or larger than the predetermined value may be determined as the feature point of which the user is about to designate the position.

The display control unit 240 displays a pointer operated by the user and an input image on the screen. The display control unit 240 may also display feature points (positions of feature points) in addition to the pointer and the input image. Further, regarding the feature points, all the detected feature points may be displayed, or only some of the feature points may be displayed. By displaying all the detected feature points, the user can easily check as to where he/she should designate a feature point. Further, the visibility for the user can be improved by setting feature points to be displayed and those not to be displayed, such as displaying only some of the feature points. For example, it is possible to inform the user of a feature point to which he/she should pay attention by displaying only the feature point that the user should designate, or by repeatedly displaying and hiding only the feature point that user should designate in a blinking manner while continuously hiding the other feature points. Further, the display control unit 240 moves the pointer to the first position by using the fact that the receiving unit 220 has received the first input as a trigger.

In the database 250, input images from which the calculation unit 210 calculates feature points are stored. In this example embodiment, the stored input image is an image including a face, but is not limited to such images. That is, the stored input image may be any image from which certain feature points can be extracted, such as an image including an automobile, road surface conditions, or a person. For example, the input support system 200 may be used to perform input support described below in order to detect a lesion from an image taken inside a human body or the like acquired by an endoscope camera. That is, after the lesion is calculated as a feature point by the calculation unit 210, the display control unit 240 may assist a medical specialist to designate the correct position of the feature point by moving the pointer. In this way, it is possible to create learning data according to expert knowledge and to improve detection accuracy. This example embodiment can be effectively used for input support when a feature point is manually associated with a meaningful object or the like or the accuracy of a feature point is manually improved after the feature point is detected by image processing, or can be effectively used for input support in the case where the confirmation by a specialist is required for the designation of a feature point.

### Explanation of Operation

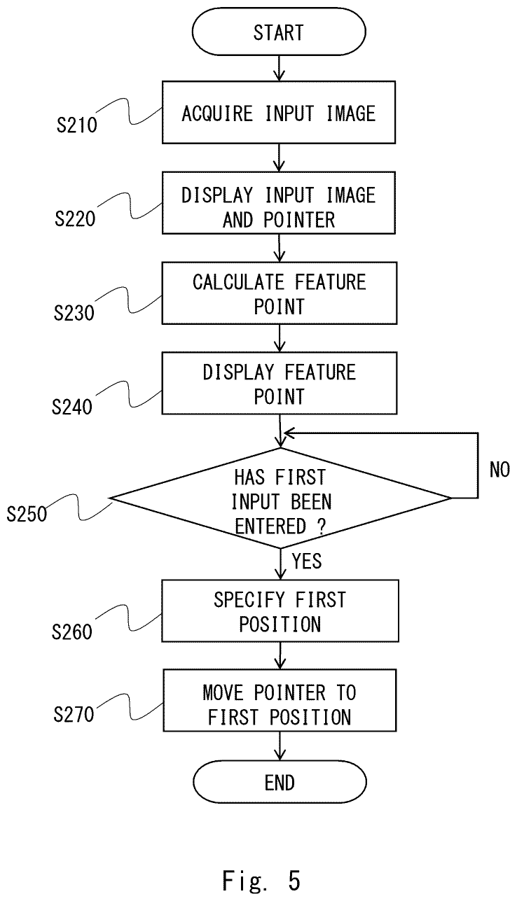

FIG. 5 is a flowchart showing operations performed by the input support system 200 in the second example embodiment. A series of processes performed by the input support system 200 will be described with reference to FIG. 5.

The calculation unit 210 acquires a face image as an input image from the database 250 (Step S210). Note that the calculation unit 210 may acquire an image from an external apparatus such as an external camera.

As shown in FIG. 4, the display control unit 240 displays the input image 20 acquired by the calculation unit 210 and the pointer 22 that the user operates on the screen (Step S220). However, the timing at which the step S220 is performed is not limited to this example, and the step S220 may instead be performed at any timing after the calculation unit 210 acquires the image in the step S210 and before the process of moving the pointer to the first position in the step S270 (which will be described later).

The calculation unit 210 calculates feature points on the face from the acquired face image (Step S230).

The display control unit 240 displays the feature points on the face calculated by the calculation unit 210 on the screen (Step S240). However, the timing at which the display control unit 240 performs the step S240 is not limited to this example, and the step S240 may instead be performed at any timing after the step S230 and before the end of the flow. Alternatively, the step S240 may not be performed, so that the calculated feature points may not be displayed on the screen. By not displaying the feature points, it is possible to make the user input feature points based solely on his/her knowledge while ensuring the operability. That is, in this case, the user inputs feature points based solely on his/her knowledge without relying on the positions of feature points suggested by the calculation unit 210.

The receiving unit 220 determines whether or not a first input has been received from the user (Step S250). When the first input has not yet been received, the receiving unit 220 waits until the first input is received from the user. When the receiving unit 220 receives the first input, the process moves to the next step S260.

When the receiving unit 220 has received the first input, the specifying unit 230 specifies the first position based on the feature point calculated in the step S230 (Step S260). A plurality of feature points may be calculated. Therefore, for such a case, it may be determined in advance which feature point is used to specify the first position. For example, when the input image is a face image and it is determined in advance to specify the first position by using the feature point of the outer corner of the left eye, the specifying unit 230 specifies the position of the feature point of the outer corner of the left eye as the first position from among the feature points calculated in the step S230. Further, the step S260 may be performed before the step S250, i.e., before the first input is received.

The display control unit 240 controls the display so that the position of the pointer moves to the first position specified by the specifying unit 230 (Step S270).

### Explanation of Hardware Configuration

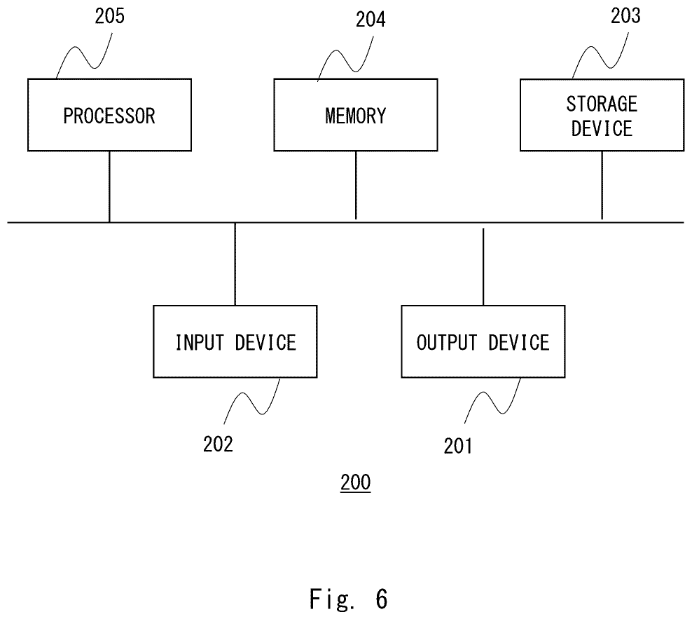

FIG. 6 is a block diagram showing an example of a hardware configuration of the input support system 200. As shown in FIG. 6, the input support system 200 includes an output device 201, an input device 202, a storage device 203, a memory 204, and a processor 205.

The output device 201 is an output device such as a display for outputting information to the outside. The display may be, for example, a flat panel display such as a liquid crystal display, a plasma display, or an organic EL (Electro-Luminescence) display. The output device 201 displays the input image, feature points, and the pointer output by the display control unit 240. The output device 201 receives, from the display control unit 240, which has acquired the first position from the specifying unit 230, an instruction to move the pointer from the currently-displayed position to the first position and output the moved pointer, and thereby displays the pointer at the first position.

The input device 202 is a device by which the user enters an input, and is, for example, a pointing device or an input device such as a keyboard. Examples of the pointing device include a mouse and a trackball. The operation input by the input device 202 is, for example, but not limited to, an operation for clicking a button on a mouse or an operation for moving a mouse. For example, this operation may be an input of a predetermined key on a keyboard, and may be any operation as long as it is predetermined as an operation for designating the position of a feature point or an operation for moving the pointer to a feature point to be designated. When this operation for designating the position of a feature point or an operation for moving the pointer to a feature point to be designated is input by the input device 202, the receiving unit 220 determines that a first input has been received.

The storage device 203 is a nonvolatile storage device such as a hard disk drive or a flash memory. The above-described database 250 and databases in other example embodiments described later are implemented by the storage device 203, but they may be implemented by other storage devices such as a server or a cloud system. Further, the storage device may be, in addition to or instead of being connected to other hardware by an electric circuit, capable of communicating information through a wireless signal or the Internet. Further, the storage device may be formed by a single device or a plurality of devices.

The memory 204 is formed by, for example, a combination of a volatile memory and a nonvolatile memory. The memory 204 is used to store software (computer program) including at least one instruction performed by the processor 205 and data used for various processes performed by the input support system 200. The memory 204 may include a plurality of memories.

The processor 205 loads and executes software (computer program) from the memory 204, and thereby performs the processes performed by the above-described calculation unit 210, the receiving unit 220, the specifying unit 230, and the display control unit 240. Note that in other example embodiments, the processor 205 also loads and executes software (computer program) from the memory 204, and thereby performs the processes performed by the input support system according to the respective example embodiment in a similar manner. The processor 205 may be, for example, a microprocessor, an MPU (Micro Processor Unit), or a CPU (Central Processing Unit). The processor 205 may include a plurality of processors.

As described above, the input support system 200 has functions as a computer.

The program includes a set of instructions (or software codes) that, when read into a computer, causes the computer to perform one or more of the functions described in the example embodiments. The program may be stored in a non-transitory computer readable medium or in a physical storage medium. By way of example rather than limitation, a computer readable medium or a physical storage medium may include a random-access memory (RAM), a read-only memory (ROM), a flash memory, a solid-state drive (SSD), or other memory technology, a CD-ROM, a digital versatile disc (DVD), a Blu-ray (Registered Trademark) disc or other optical disc storages, a magnetic cassette, magnetic tape, and a magnetic disc storage or other magnetic storage devices. The program may be transmitted on a transitory computer readable medium or a communication medium. By way of example rather than limitation, the transitory computer readable medium or the communication medium may include electrical, optical, acoustic, or other forms of propagating signals.

Note that the hardware configuration of the input support system 200 described above applies to input support systems according to other example embodiments, except when it is specifically mentioned otherwise.

### Explanation of Effect

A user of the input support system 200 can move the pointer to the vicinity of the feature point that he/she intends to designate by simply entering a predetermined first input. As a result, the amount of operation that the user needs to perform to move the pointer to the position of the feature point can be reduced, so that the workload of the inputting work performed by the user can be reduced.

### Third Example Embodiment

Next, a third example embodiment will be described. The third example embodiment differs from the second example embodiment in that the order of feature points in which the user should designate them is acquired and a second input is received. The second input is a predetermined input for instructing to return the position of the moved pointer to the position in the past. This second input may also be referred to as a return input. Note that in other example embodiments described later, the second input also refers to the input described hereinafter.

Differences from the second example embodiment will be described hereinafter in a concrete manner, and redundant descriptions will be omitted as appropriate. Note that the first example embodiment described above may be applied to the third example embodiment, and/or the second example embodiment described above may be applied thereto.

### Explanation of Configuration

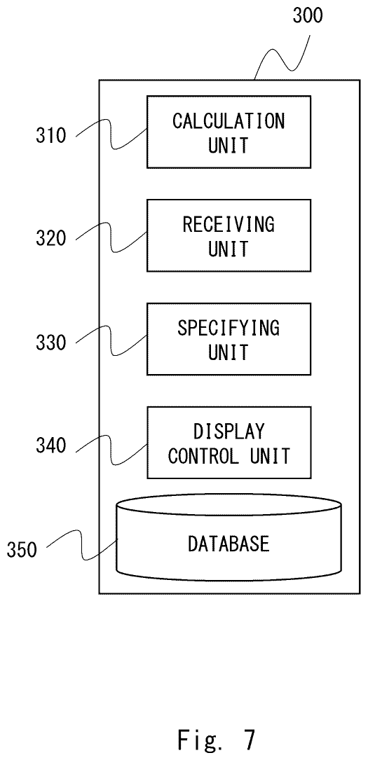

FIG. 7 is a block diagram showing an example of a configuration of an input support system according to the third example embodiment. As shown in FIG. 7, the input support system 300 includes a calculation unit 310, a receiving unit 320, a specifying unit 330, a display control unit 340, and a database 350.

In the database 350, input images from which the calculation unit 310 calculates feature points are stored. Further, a machine learning model by which the calculation unit 310 calculates feature points corresponding to an input image through machine learning may be stored. Further, in addition to input images, information on feature points corresponding to the input images may be stored. The information on feature points may include positions of the feature points, labels of the feature points, the order of the feature points, and the like.

The machine learning model is trained in advance through machine learning such as deep learning by using pairs of images and positions of feature points of objects shown in the images as training data. In this training data, the positions of the feature points are designated in advance, for example, by a person skilled in work for designating positions of feature points. Therefore, positions of feature points can be calculated from an input image by this machine learning model. Further, the machine learning model may be trained by using the training data in which the order of feature points is also associated. In this case, the order of feature points as well as positions of feature points can be calculated by inputting an input image into the machine learning model.

The position of a feature point included in the information on the feature point is the position of the feature point in the input image. For example, in the database 350, positions of feature points on a two-dimensional plane corresponding to the input image are stored as information on the feature points.

The label of a feature point indicates what the feature point in the image is for. For example, labels attached to feature points in a face image indicates parts of the face such as a nose, a mouth, and eyes. If a label is further divided into sub-labels, they indicate more detailed parts of the face, such as the outer corner of the left eye, the outer corner of the right eye, the left wing of the nose, and the right wing of the nose.

The order of feature point is, when a user designates positions of a plurality of feature points, the order of designation of the feature points. When data about a group of feature points included in one input image is generated based on the designation of positions of the feature points by a user, there is a case where it is necessary to generate data in which the positions of the feature points are designated in a predetermined order. In this case, the user needs to designate the positions of the feature points in the predetermined order. For example, in the case of a group of feature points in a face image, there is a case where it is necessary to generate data in which the positions of the feature points are designated in the order of predetermined parts, for example, in the order of the outer corner of the left eye, the left pupil, the inner corner of the left eye, and the outer corner of the right eye. In such a case, for example, a feature point corresponding to the outer corner of the left eye is a first feature point; a feature point corresponding to the left pupil is a second feature point; a feature point corresponding to the inner corner of the left eye is a third feature point; and a feature point corresponding to the outer corner of the right eye is a fourth feature point.

The calculation unit 310 may calculate feature points and the above-described order of the feature points, which is the order in which the user inputs the feature points, from the input image. For example, when a face image is input as an input image, the calculation unit 310 calculates a feature present on the surface of the human face as a feature point, detects which part of the face this feature point is calculated for, and determines the order of this calculated feature point based on the predetermined order of parts. In this way, the order of feature points is calculated. Although the face image is described as an example of the input image in this example, the feature of this example embodiment described above can be applied to other images as described in the second example embodiment.

Further, the calculation unit 310 may calculate feature points and the order of the feature points as follows. The calculation unit 310 can calculate, in addition to feature points, the order of the feature points in which the user should input the feature points by reading a machine learning model trained to output feature points and the order of the feature points from the database 350 and inputting an input image into the machine learning model.

Further, the calculation unit 310 may also calculate feature points and the order of the feature points as follows. When the calculation unit 310 reads information on feature points from the database 350, it can calculate feature points and the order of the feature points by referring to the information on the feature points. For example, when a corresponding relationship between positions of feature points and labels of the feature points is included in the information on the feature points, the calculation unit 310 can calculate the order in which the user should input the feature points by comparing parts indicated by the labels of feature points located at the respective positions with the order of parts determined in advance.

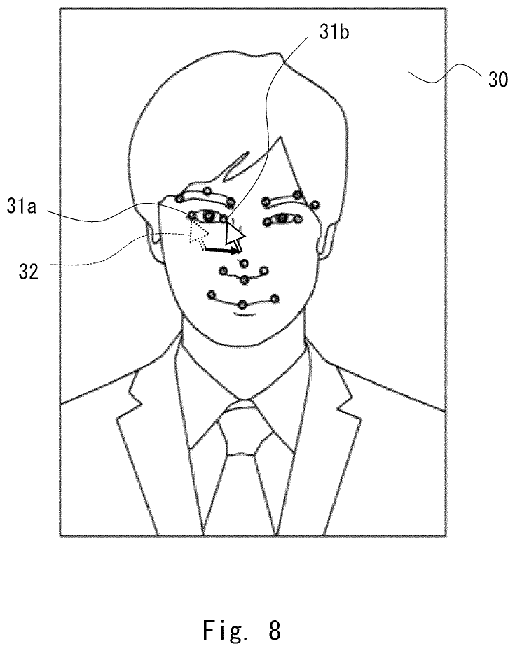

The specifying unit 330 specifies a first position related to a feature point. In this example embodiment, the first position related to a feature point is specified based on positions of feature points and the order of the feature points. The specifying unit 330 acquires the positions of feature points and the order of the feature points from the calculation unit 310 or the database 350. For example, as shown in FIG. 8, when the order of feature points calculated from an input image 30 by the calculation unit 310 is an order of a feature point 31a of the outer corner of the right eye and a feature point 31b of the inner corner of the right eye, the first position is the position of the feature point 31a of the outer corner of the right eye. After that, when the receiving unit 320 further receives a first input (designation start input), the next first position is the position of the feature point 31b of the inner corner of the right eye. The specifying unit 330 may specify one first position each time the receiving unit 320 receives a first input, or may specify a plurality of first positions when it receives one first input. The timing at which the specifying unit 330 specifies the first position is not limited to this example, and may instead be any timing after feature points and the order of the feature points are calculated by the calculation unit 310. Further, when positions of feature points and the order of the feature points are stored as information on the feature points in association with the input image in the database 350, the specifying unit 330 may acquire positions of feature points and the order of the feature points from the database 350 and specify the first position related to the feature point.

The display control unit 340 moves the pointer to the first position by using the fact that the receiving unit 320 has received the first input as a trigger. Therefore, when the receiving unit 320 receives the first input, the display control unit 340 moves the pointer 32 to the position of the feature point 31a, which is the first position, as shown in FIG. 8. When the receiving unit 320 receives the first input again, the specifying unit 330 updates the first position to the position of the feature point 31b in order to make the user designate the feature point located at the inner corner of the right eye, which is the next feature point. Then, the display control unit 340 moves the pointer to the position of the feature point 31b so that the pointer moves to the updated first position. Note that all of the first inputs do not have to correspond to the same operation. For example, first, an operation for moving the pointer is received as the first input, and the pointer is moved to the position of the first feature point. Next, an operation for designating this feature point is received as the first input, and the pointer is moved to the second feature point. Referring to FIG. 8, as an operation for moving the pointer is received as the first input, the pointer 32 moves to the position of the feature point 31a. Then, next, as an operation for designating the position for the feature point 31a as the first input, the pointer 32 moves to the position of the feature point 31b.

Further, the specifying unit 330 may specify a second position related to a feature point. While the position of the first position is specified so that it moves in the order in which the user inputs feature points, the second position related to the feature point is specified so that it moves in the order that is reversed from the order in which the user inputs the feature point. Note that in other example embodiments described later, the second position also refers to the position described hereinafter.

The receiving unit 320 may receive a second input in addition to the function of the receiving unit 220 according to the second example embodiment. While the first input (designation start input) is an operation for moving the pointer in the order in which feature points are input, the second input (return input) is an operation for moving the pointer in the order that is the reverse of the order in which feature points are input. By entering the second input, the pointer can be returned to the feature point which the pointer has passed before the pointer moved to the current position. The second input is an input operation different from the one that is defined as the first input. The second input is, for example, but not limited to, an operation for clicking a button on a mouse or an operation for moving a mouse. For example, this operation may be an input of a predetermined key on a keyboard, and may be any operation as long as it is predetermined as an operation for moving the pointer to the position of the feature point. For example, when left clicking corresponds to the first input, the position of the pointer can be moved to the position of the predetermined feature point in the reversed direction by performing right clicking as the second input.

In addition to the function of the display control unit 240 according to the second example embodiment, the display control unit 340 moves the pointer to the second position by using the fact that the receiving unit 320 receives the second input as a trigger. Therefore, after the first input is received, when the pointer 32 has been moved from the feature point 31a to the position of the feature point 31b as shown in FIG. 8, the specifying unit 330 specifies the second position as follows. That is, the specifying unit 330 specifies the feature point 31a as the second position so that the pointer returns to the feature point 31a located at the outer corner of the right eye, which is in the direction reversed from the order of the parts. As described above, the specifying unit 330 specifies the second position by going back transitions of the specified first positions (i.e., by going back the past movements through the specified first positions). For example, each time the receiving unit 320 receives the second input, the specifying unit 330 specifies the second position by going back one transition of the specified first position. The display control unit 340 moves the pointer from the feature point 31b to the position of the feature point 31a so that the pointer moves to the second position. That is, the display control unit 340 returns the position of the pointer. The specifying unit 330 and the display control unit 340 can also be described as follows. The specifying unit 330 specifies a new first position and further specifies a second position. The second position can also be described as a first position specified before the new first position. The display control unit 340 moves, upon receiving the second input from the user, the pointer to the second position. More specifically, the specifying unit 330 specifies the first position according to the order in which the user inputs positions related to feature points, and specifies the first position immediately preceding the new first position as the second position according to the order that is the reverse of the order used for specifying the first positions.

### Explanation of Operation

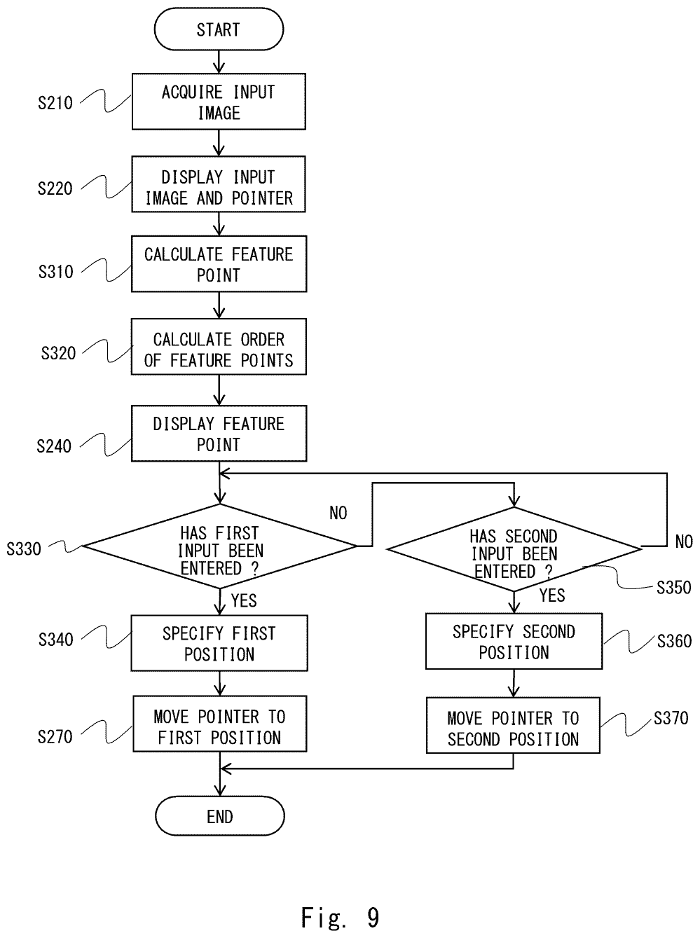

Next, operations performed by the input support system 300 according to the third example embodiment will be described with reference to a flowchart. FIG. 9 is a flowchart showing an example of operations performed by the input support system 300 according to the third example embodiment. As shown in FIG. 9, the flowchart shown in this example differs from the flowchart shown in FIG. 5 in that steps S310 to S370 are newly performed. Further, since steps S210, S220, S240 and S270 in FIG. 9 differ only in that operations performed by the calculation unit 210 and the display control unit 240 described above with reference to FIG. 5 are performed by the calculation unit 310 and the display control unit 340, respectively, redundant descriptions thereof will be omitted. Differences from the flowchart shown in FIG. 5 will be described hereinafter.

After the calculation unit 310 acquires an image from the database 350 in the step S210, the calculation unit 310 calculates feature points and the order of the feature points in which the user should designate the feature points (Steps S310 and S320). In the step S310, the calculation unit 310 calculates feature points based on a machine learning model read from the database 350. Note that the feature points may not be calculated by the method using machine learning, and may instead be calculated from the input image or may be calculated based on information on feature points as described above. In the step S320, the calculation unit 310 calculates the order of feature points by using the machine learning model read from the database 350. Note that instead of using the calculation method described above, the order of feature points may be calculated based on feature points calculated from the image and the order of parts, or may be calculated from information on feature points associated with the acquired image. Although the step S320 is performed after the step S310 in FIG. 9, they may be simultaneously performed.

The receiving unit 320 determines whether or not the first input is received from the user (Step S330). When neither the first input nor the second input is entered, the receiving unit 320 waits until the first or second input is received from the user. When the receiving unit 320 receives the first input, the process moves to the next step S340.

The specifying unit 330 specifies the first position based on the feature points and the order of the feature points calculated by the calculation unit 310 (Step S340). As described above, the specifying unit 330 specifies the first position based on the order in which the user inputs positions related to feature points. After performing the step S340, the process proceeds to the step S270, and the flow is finished when the display control unit 340 displays the pointer at the first position. Note that the timing at which the step S340 is performed is not limited to this example, and may instead be any timing after the order of feature points is calculated in the step S320 and before the process for moving the pointer to the first position is performed in the step S270.

The receiving unit 320 determines whether or not a second input is received from the user (Step S350). When the receiving unit 320 receives the second input, the process proceeds to the next step S360. Therefore, when the first input or the second input had been received, the receiving unit 320 performs an operation for proceeding the process to the process corresponding thereto.

When the receiving unit 320 receives the second input, the specifying unit 330 specifies the immediately preceding position of the feature point as the second position based on the order of feature points in which the user should designate the feature points (Step S360). The timing at which the step S360 is performed is also not limited to this example, and may instead be any timing after the order of feature points is calculated in the step S320 and before the process for moving the pointer to the second position is performed in the step S370.

In addition to operations performed by the display control unit 240 in the second example embodiment, the display control unit 340 displays the pointer at the second position specified by the specifying unit 330 when the receiving unit 320 receives the second input (Step S370).

### Explanation of Effect

The input support system 300 in the third example embodiment can move the pointer to the vicinity of the feature point that the user should designate by using the first input as a trigger, and return the pointer to the preceding position of the feature point by going back the transitions by using the predetermined second input as a trigger. In this way, the input support system 300 can move the pointer to the vicinity of the feature point one after another while reducing the amount of operation that the user needs to perform in order to move the pointer to the position of the feature point. Further, since the input support system 300 can return the pointer to the preceding position of the feature point, the user can redo the designation of feature points. As a result, the input support system 300 can reduce the workload of the work for inputting feature points performed by the user. Further, in this example embodiment, the calculation unit 310 calculates the order in which the user inputs positions related to feature points from the input image. Therefore, the order is automatically calculated, so that a highly usable system is provided.

### Fourth Example Embodiment

Next, a fourth example embodiment will be described. The fourth example embodiment differs from the third example embodiment in that the calculation unit calculates a bounding box instead of calculating a feature point.

Differences from the third example embodiment will be described hereinafter in a concrete manner, and redundant descriptions will be omitted as appropriate. Note that the first, second, and third example embodiments described above can also be applied to the fourth example embodiment.

### Explanation of Configuration

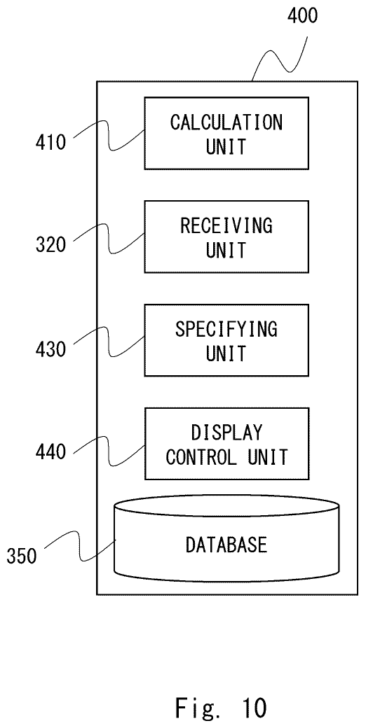

FIG. 10 is a block diagram showing an example of a configuration according to the fourth example embodiment. As shown in FIG. 10, an input support system 400 includes a calculation unit 410, a receiving unit 320, a specifying unit 430, a display control unit 440, and a database 350.

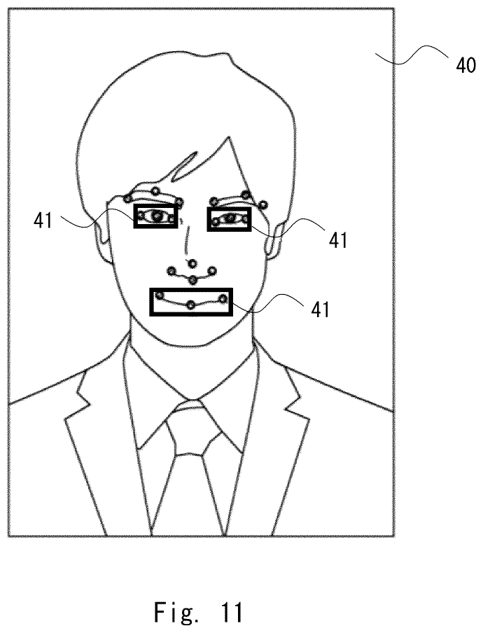

The calculation unit 410 calculates a bounding box from an input image. The bounding box is composed of polygonal boundary lines that surrounds an object shown in an image, such as a person, a face, a part of a face (such as an eyebrow, an eye, a nose, a mouth, an ear), and an automobile. The bounding box can be regarded as boundary lines that surrounds feature points constituting an object. When a face image is input as an input image in order to designate a bounding box for, for example, an eye in a face, the calculation unit 410 calculates a bounding box 41 surrounding features present on the surface of the human face from an input image 40 as shown in FIG. 11. More specifically, the calculation unit 410 calculates vertices of a bounding box.

Although a face image has been described as an example of the input image in this example, the present disclosure can also be applied to other images. For example, this example embodiment may be implemented in a series of operations in which an image acquired from an in-vehicle camera mounted in a car is transmitted to a server or to a device connected to the in-vehicle camera, and then a user designates a depression, a groove or the like on the road surface, a car, a person, or the like by using a bounding box. In this way, it is possible to assist the user to input a bounding box. Then, it is possible to support the creation of learning data for machine learning. By using a machine learning model trained by using this learning data, it is possible to accurately specify an object such as a person or a car from a video image obtained when the car is running or when an accident has occurred by using a bounding box. The result of this specified bounding box or the like can also be used to determine the driving skill or to calculate the ratio of negligence in a traffic accident. Further, by inputting images acquired from cameras installed in various environments, such as cameras directed at roads or facilities, into the input support system 400, it is possible to assist the user to create learning data that is used for learning an automobile or the movement of the face or body of a pedestrian shown in an image. By supporting operations for designating an entire person or parts such as a face or body from an image acquired by a camera by a bounding box by using this example embodiment, it is possible to create learning data in machine learning more easily. By using a model trained by using this learning data, a person shown in an image taken by a camera may be tracked by using a bounding box. Then, based on the feature points in the bounding box, it is also possible to identify the person and/or detect suspicious behavior.

Further, the bounding box and the input image that the user wants to designate can be changed as appropriate. Further, the calculation unit 410 may calculate the order of bounding boxes in which the user should designate the bounding boxes in a manner similar to the calculation of the order of feature points in the third example embodiment. In this example embodiment, an example embodiment in which a face image is used as the input image, and the designation of a rectangular bounding box for each of parts in a face is supported will be described.

A calculation method similar to the calculation of a feature point by using a machine learning model described in the third example embodiment can be used for the calculation of a bounding box. However, while pairs of images and positions of feature points related to objects are used as training data for the training of a machine learning model described in the third example embodiment, for example, pairs of images and bounding boxes related to objects are used as training data for the calculation of a bounding box. Further, a bounding box may be calculated based on a positional relationship between feature points calculated by the method described in the third example embodiment.

The specifying unit 430 specifies vertices of the bounding box calculated by the calculation unit 410 as the first position. In this example embodiment, since a rectangular bounding box is designated, at least two vertices need to be designated in order to designate one bounding box. Therefore, for example, in order to designate a bounding box for the left eye, the user is made to designate the upper left vertex of the bounding box, and then to designate the lower right vertex thereof, so that the bounding box for the left eye can be designated. That is, in this case, the specifying unit 430 specifies the upper left vertex of the bounding box calculated by the calculation unit 410 as the first position, and then specifies the lower right vertex of this bounding box as the next first position. Further, in addition to or instead of this method, the specifying unit 430 may specify the first position and the second position by making the user designate each vertex according to the shape of the bounding box to be designated. Further, when the order of bounding boxes has already been calculated by the calculation unit 410, the first position and the second position can be specified based on the vertices of the bounding boxes and the order thereof. As described above, the specifying unit 430 may specify the first position or the second position based on the order in which the user inputs positions related to feature points.

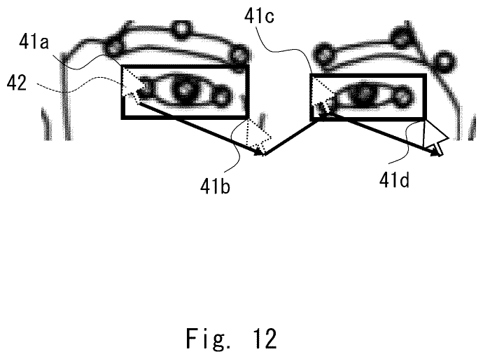

The display control unit 440 moves the pointer to the first position by using the fact that the receiving unit 320 receives the first input (designation start input) as a trigger. Therefore, each time the first input is received, the display control unit 440 successively moves the pointer 42 to the vertices 41a, 41b, 41c and 41d of the respective bounding boxes calculated by the calculation unit 410 as shown in FIG. 12. In this way, the bounding boxes of the respective parts in the face can be successively designated in the order of the bounding box of the right eye and the bounding box of the left eye. Specifically, first, when a first input is received, the pointer 42 is moved to the position of the upper left vertex 41a of the bounding box, which is the first position. When the receiving unit 320 receives a first input again, the specifying unit 430 updates the first position to the lower right vertex 41b of the bounding box in order to make the user designate the position of the vertex of the bounding box that should be designated next. Upon this updating, the display control unit 440 moves the pointer to the vertex 41b so that the pointer moves to the updated first position. Note that when a second input (return input) is received after the pointer is moved to the vertex 41b of the bounding box, the specifying unit 430 specifies the vertex 41a of the bounding box as the second position, and the display control unit 440 can move the pointer so as to return it to the second position.

### Explanation of Operation

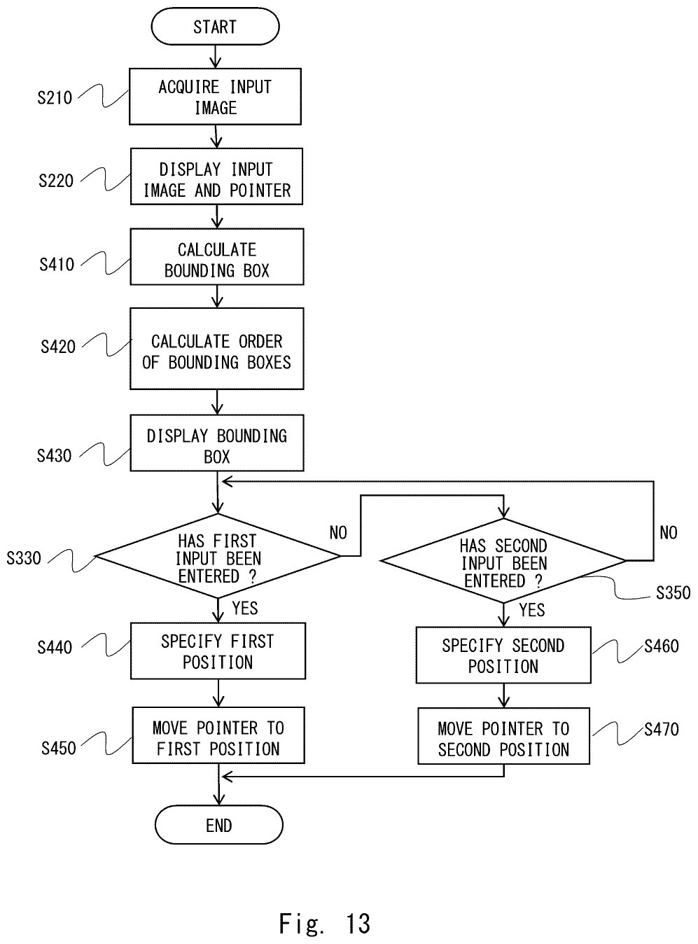

Next, operations performed by the input support system 400 according to the fourth example embodiment will be described with reference to a flowchart. FIG. 13 is a flowchart showing an example of operations performed by the input support system 400 according to the fourth example embodiment. As shown in FIG. 13, the flowchart shown in this example differs from the flowchart shown in FIG. 9 in that steps S410 to S470 are newly performed. Further, since steps S210 and S220 in FIG. 13 differ only in that operations performed by the calculation unit 310 and the display control unit 340 described above with reference to FIG. 9 are performed by the calculation unit 410 and the display control unit 440, respectively, redundant descriptions thereof will be omitted. Further, since the operations in steps S330 and S350 are similar to the operations described above, redundant descriptions thereof will be omitted. Differences from the flowchart shown in FIG. 9 will be described hereinafter.

After an image is acquired from the database 350 in the step S210, the calculation unit 410 calculates bounding boxes and the order of the bounding boxes in which the user should designate the bounding boxes (Steps S410 and S420). The order of bounding boxes is determined based on a predetermined order of objects for which bounding boxes are designated and a predetermined order in which vertices of the bounding box of one object are designated. For example, in a case where a rectangular bounding box is to be designated for each of parts in a face, as the order regarding the rectangular bounding boxes, an order of the upper left vertex of a bounding box for the right eye, the lower right vertex of a bounding box for the right eye, the upper left vertex of a bounding box for the left eye, and the lower right vertex of a bounding box for the left eye is calculated. As described above, the order may be calculated so that the upper left vertices and the lower right vertices of the bounding boxes corresponding to the respective parts can be selected one after another.

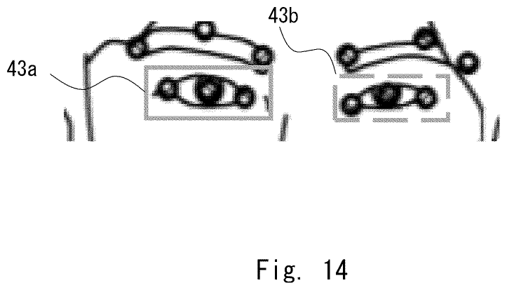

The display control unit 440 displays the bounding box calculated by the calculation unit 410 on the screen (Step S430). However, the timing at which the display control unit 440 performs the step S430 is not limited to this example, and the step S430 may instead be performed at any timing after the step S410 and before the end of the flow. By displaying the bounding box, the user is assisted to perform operations. The displayed bounding box may be shown by lines lighter than predetermined darkness as shown as a bounding box 43a in FIG. 14, or may be shown by dashed lines as shown in a bounding box 43b therein, so that it can be understood that the bounding box is displayed just for a reference purpose. Alternatively, the step S430 may not be performed, so that the calculated bounding box may not be displayed on the screen. By not displaying the bounding box, it is possible to input the bounding box based solely on the knowledge of the user while ensuring the operability. That is, in this case, the user inputs the bounding box based solely on his/her knowledge without relying on the position of the bounding box suggested by the calculation unit 410.

In the step S330, when the receiving unit 320 receives the first input from the user, the specifying unit 430 specifies the first position based on the bounding boxes and the order of the bounding boxes calculated by the calculation unit 410 (Step S440). Note that the timing at which the step S440 is performed is not limited to this example, and may instead be any timing after the order of bounding boxes is calculated in the step S420 and before the process for moving the pointer to the first position is performed in the step S450.

When the receiving unit 320 receives the first input, the display control unit 440 displays the pointer at the first position specified by the specifying unit 430 (Step S450).

In the step S350, when the second input is received from the user, the specifying unit 430 specifies the second position based on the bounding boxes and the order of the bounding boxes calculated by the calculation unit 410 (Step S460). The specifying unit 430 specifies the second position by going back the transitions of the specified first positions. As described above, the position of the second position related to the bounding box is specified so that it moves in the order that is reversed from the order in which the user inputs the vertices of the bounding boxes. The timing at which the step S460 is performed is also not limited to this example, and may instead be any timing after the order of bounding boxes is calculated in the step S420 and before the process for moving the pointer to the second position is performed in the step S470.

When the receiving unit 320 receives the second input, the display control unit 440 displays the pointer at the second position specified by the specifying unit 430 (Step S470).

### Explanation of Effect

In the input support system 400 in the fourth example embodiment, bounding boxes and the order thereof are calculated by the calculation unit 410. Then, the display control unit 440 moves the pointer to an appropriate position by using the first input or the second input entered by the user as a trigger. In this way, the input support system 400 can make the user designate bounding boxes one after another while reducing the amount of operation in the pointer moving operation in the work for designating the areas of bounding boxes performed by the user. As a result, the input support system 400 can reduce the workload of the inputting work performed by the user.

### Fifth Example Embodiment

Next, a fifth example embodiment will be described. The fifth example embodiment is different from the other example embodiments in that a warning unit for issuing a warning based on a comparison between a calculated feature point and a feature point designated by a user is newly provided. Differences from the other example embodiments will be described hereinafter in a concrete manner, and redundant descriptions will be omitted as appropriate.

### Explanation of Configuration

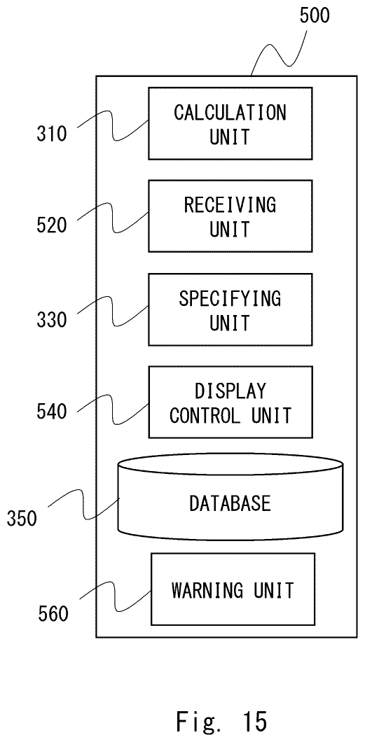

FIG. 15 is a block diagram showing an example of a configuration of an input support system according to the fifth example embodiment. As shown in FIG. 15, the input support system 500 includes a calculation unit 310, a receiving unit 520, a specifying unit 330, a display control unit 540, a database 350, and a warning unit 560.

The receiving unit 520 receives an operation that a user performs to designate a feature point. Note that this operation may be received as a first input (designation start input) as described in the above-described example embodiments. Further, the receiving unit 520 may receive an operation for designating a bounding box instead of the operation for designating a feature point. Further, the receiving unit 520 may receive a first input separately from the operation for designating a feature point performed by the user. Further, the receiving unit 520 may receive a second input (return input).

The display control unit 540 performs processes similar to those performed by the display control unit of any of the above-described example embodiments. However, the display control unit 540 may further display, when the receiving unit 520 receives an operation for designating a feature point from the user, the designated feature point over the image in a superimposed manner. In this way, the user can check where he/she has designated the feature point.

The warning unit 560 outputs a warning based on a distance between the position of the feature point calculated by the calculation unit 310 and the position of the feature point designated by the user received by the receiving unit 520. Specifically, the warning unit 560 determines whether the distance between the position of the feature point calculated by the calculation unit 310 and the position of the feature point received by the receiving unit 520 is equal to or longer than a predetermined distance. Then, when the warning unit 560 determines that the distance is equal to or longer than the predetermined distance, it displays a warning for the user in the output device 201. For example, after the pointer has moved to the first position, when the distance of the position of the feature point designated by the user from the position that the calculation unit 310 has calculated for the feature point corresponding to this first position is equal to or longer than the predetermined distance, the warning unit 560 outputs a warning. Note that as the warning, a warning sound can also be output from a speaker provided inside or connected to the input support system. In this way, the user can recognize that his/her input is different from the position of the feature point calculated by the calculation unit 310. It is possible to suggest the possibility of an incorrect input or suggest that the designation of the feature point, which has been made based on his/her knowledge, may be incorrect. Note that the state where the distance is equal to or longer than the predetermined distance means, for example, a state where the distance between the two points is several tens of pixels or longer. Therefore, the user can recognize an incorrect input or the like by the warning, thus making it possible to designate a feature point more accurately. The aforementioned predetermined distance can be set as appropriate by the user. When the predetermined distance is reduced, the determination is made more strictly so that the designation of a feature point conforms to the position of the feature point calculated by the calculation unit 310 more closely. Further, even in the case of the configuration in which a bounding box is designated instead of a feature point, it is possible to determine whether a warning should be issued or not by comparing the position of a specific vertex(es) of the bounding box calculated by the calculation unit 410 with the position of the specific vertex(ex) of the bounding box designated by the user. As described above, the warning unit 560 issues a warning when the position related to a feature point (the position of a feature point or a bounding box) calculated by the calculation unit 310 and the position related to a feature point (the position of a feature point or a bounding box) input by the user are away from each other by a predetermined distance or longer. In this example embodiment, an example embodiment in which an operation for designating a feature point is performed will be described. Note that the input support system according to the example embodiment is a system that assists a user (human being), who watches an input image, to determine the position of a feature point or the position of a bounding box in this input image. Therefore, it is expected that by using the input support system according to the example embodiment, the position of a feature point or the position of a bounding box that is more precise than the position calculated by the calculation unit is specified by the user. Therefore, in principle, the position designated by the user is more appropriate than the position calculated by the calculation unit. Accordingly, the aforementioned warning does not necessarily indicate a mistake in the designation made by the user.

### Explanation of Operation

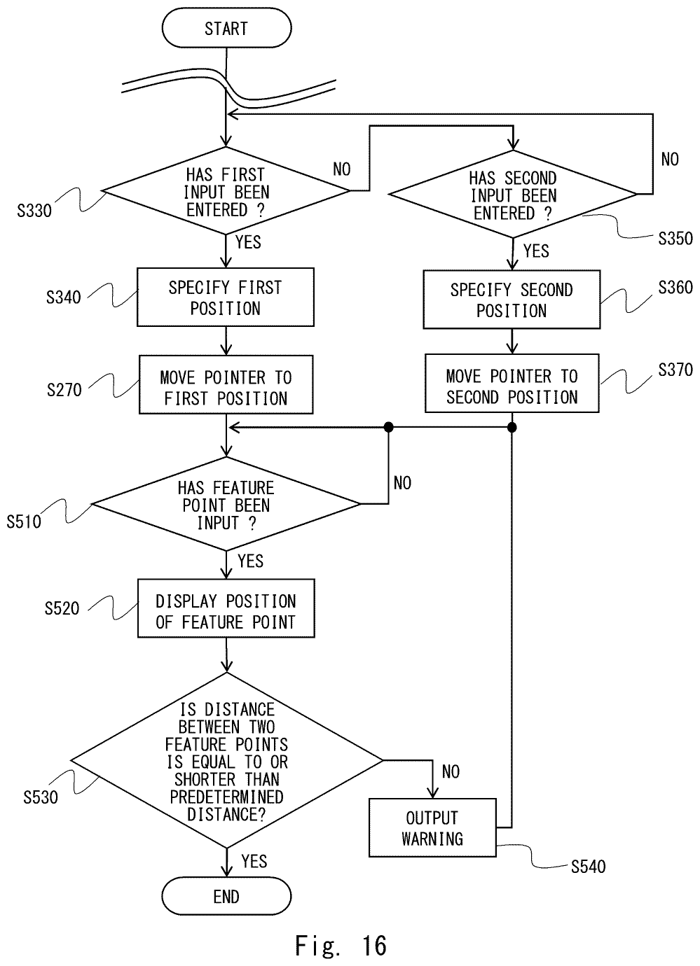

Next, operations performed by the input support system 500 according to the fifth example embodiment will be described with reference to a flowchart. FIG. 16 is a flowchart showing an example of operations performed by the input support system 500 according to the fifth example embodiment. As shown in FIG. 16, the flowchart shown in this example differs from the flowchart shown in FIG. 9 in that steps S510 to S540 are newly performed. Further, in FIG. 16, processes in steps S210 to S240 are omitted in the flowchart. The processes in these steps differs from those in FIG. 9 only in that the processes performed by the receiving unit 320 and the display control unit 340 are performed by the receiving unit 520 and the display control unit 540, respectively, and therefore they are omitted in the flowchart and descriptions thereof are omitted in the specification. Differences from the flowchart shown in FIG. 9 will be described hereinafter.

After the display control unit 540 moves the pointer to the first position or the second position in the step S270 or S370, the receiving unit 520 receives an operation for designating a feature point from the user (Step S510). When the operation for designating a feature point is received from the user, the process proceeds to the next step S520. When the operation for designating a feature point has not yet been received from the user, the system waits until the operation is received.

The display control unit 540 displays the feature point designated by the user over the image in a superimposed manner by using the fact that the receiving unit 520 has received the operation for designating the feature point from the user as a trigger (Step S520). The timing at which the step S520 is performed is not limited to this example, and the step S520 may be performed at any timing after the step S510.

The warning unit 560 compares the position of the feature point calculated by the calculation unit 310 with the position of the feature point designated by the user received by the receiving unit 520, and thereby determines whether the distance between the two points is equal to or shorter than the predetermined distance (Step S530). When the distance is longer than the predetermined distance, the process proceeds to the step S540. When the distance is equal to or shorter than the predetermined distance, the process is finished. Further, when the distance is equal to or shorter than the predetermined distance, information indicating that the user's input is correct may be output, or the user may be informed that his/her input is correct by performing the step S520 and thereby having the display control unit 540 display the feature point input by the user. Specifically, when the warning unit 560 determines that the distance between the two points is equal to or shorter than the predetermined distance, a notification for the user is displayed in the output device. Further, the user may be informed that his/her input is correct by outputting a sound for informing the user that the input is correct from a speaker provided inside or connected to the input support system.

When the distance between the two points is longer than the predetermined distance, the warning unit 560 outputs, to the display control unit 540, a warning indicting that the input of the feature point by the user does not match the feature point calculated by the calculation unit 310 (Step S540). As the display control unit 540 outputs the warning on the screen of the output device, the user can recognize that there is a possibility that his/her input is incorrect. Further, by outputting information for urging the user to input the feature point again together with the warning in the step S540, it is possible to urge the user to input the feature point again. After the warning is output in the step S540, the process proceeds (i.e., returns) to the step S510, so that the receiving unit 520 can receive an input again. Note that the receiving unit 520 may receive information indicating that the user ignores the warning from the user, and when such information is received, the process may not proceed (i.e., return) to the step S510 and may instead be finished.

### Explanation of Hardware Configuration

The hardware configuration of the fifth example embodiment is similar to that of the input support system 200 described in the second example embodiment, so that only the differences in operation will be described hereinafter.

The processor 205 further performs the process performed by the warning unit 560 described above by loading software (computer program) from the memory 204 and executing the loaded software.

### Explanation of Effect

In the fifth example embodiment, in addition to the features in the example embodiments described so far, the calculated feature point and the feature point input by the user are compared with each other. In this way, it is possible to determine (i.e., find) an incorrect input in which there is a significant difference between these feature points, or an operation in which it is determined that there is a mistake in the knowledge of the user, and output a warning therefor. Therefore, the user can recognize whether there is a possibility that his/her input is incorrect, and can designate a feature point or a bounding box more accurately.

### Sixth Example Embodiment

Next, a sixth example embodiment will be described. In the sixth example embodiment, a configuration in which the specifying unit specifies the first position and the second position based on the moving direction of the pointer operated by the user will be described in a concrete manner. Differences from the other example embodiments will be described hereinafter in a concrete manner, and redundant descriptions will be omitted as appropriate.

### Explanation of Configuration

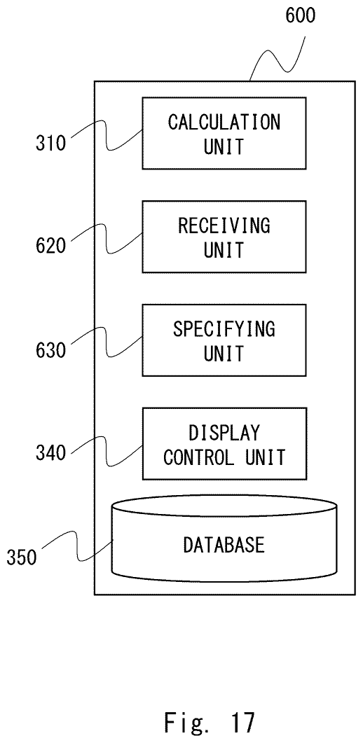

FIG. 17 is a block diagram showing an example of a configuration of an input support system according to the sixth example embodiment. As shown in FIG. 17, the input support system 600 includes a calculation unit 310, a receiving unit 620, a specifying unit 630, a display control unit 340, and a database 350.

The receiving unit 620 detects an operation that the user has performed to move the pointer to the position of a feature point that the user wants to designate by operating the input device, and receives the moving direction of the pointer as the first input (designation start input). In this process, the condition for determining whether the user's operation of the pointer is the first input or not can be set by selecting one of or combining at least two of the following conditions: 1) The pointer is at least a predetermined distance away from the calculated feature point; 2) Another operation indicating that the operation is the first input is performed simultaneously with the pointer moving operation; and 3) The acceleration of the pointer movement moved by the user's operation is equal to or larger than a threshold. By adopting the above-described condition(s), it is possible to determine whether or not the operation of the pointer is an operation that the user performs to move the pointer to the next feature point. Further, the receiving unit 620 may receive the moving direction of the pointer as the second input (return input) together with a predetermined input for instructing to return the position of the pointer, which has been moved, to the past position.

The specifying unit 630 specifies the first position based on the position of the pointer at the time when the receiving unit 620 received the first input and the moving direction of the pointer. Specifically, the specifying unit 630 searches for a feature point along the moving direction of the pointer received as the first input by using the position of the pointer at the time when the first input was received as the starting point of the search. Then, the specifying unit 630 specifies the position of the feature point that has been searched for and is closest to the position of the pointer at the time when the first input was received as the first position. As described above, the specifying unit 630 specifies the first position based on the position of the pointer at the time when the first input is received, the moving direction of the pointer, and the position related to the feature point. By using the first input to specify the first position, the first position can be specified based on the intuitive operation performed by the user, so that it is possible to assist the user to designate the feature point by performing a more intuitive operation.

### Explanation of Operation

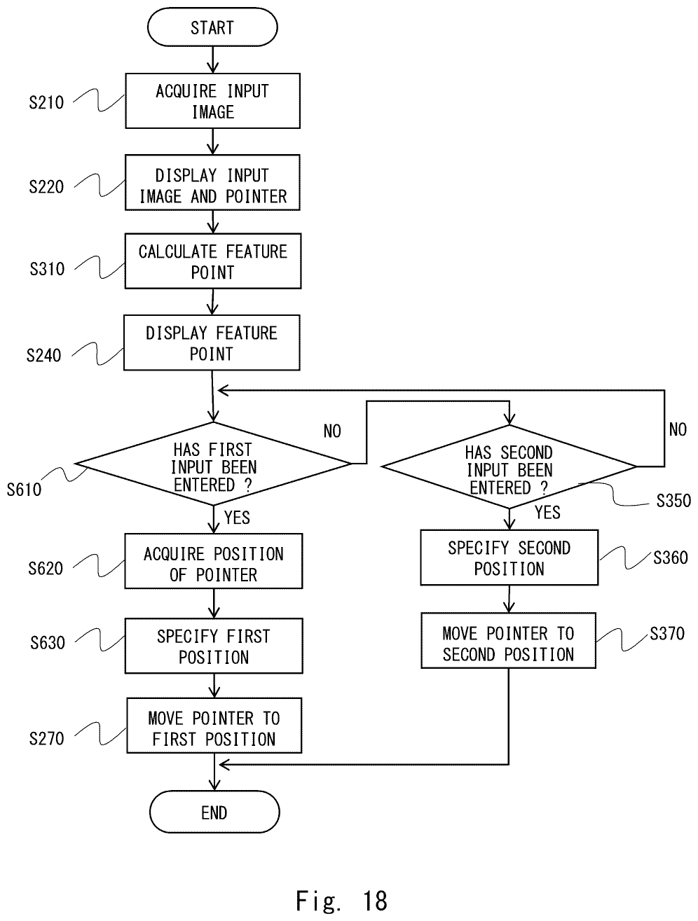

Next, operations performed by the input support system 600 according to the sixth example embodiment will be described with reference to a flowchart. FIG. 18 is a flowchart showing an example of operations performed by the input support system 600 according to the sixth example embodiment. As shown in FIG. 18, the flowchart shown in this example differs from the flowchart shown in FIG. 9 in that steps S610 to S630 are newly performed. Further, the processes in steps S210 to S240 differ from those in FIG. 9 only in that the receiving unit 620 performs the process that is performed by the receiving unit 320 in FIG. 9, so descriptions thereof are omitted. Similarly, the processes in steps S310 to S370 differ from those in FIG. 9 only in that the receiving unit 620 and the specifying unit 630 perform the processes that are performed by the receiving unit 320 and the specifying unit 330, respectively, in FIG. 9, so descriptions thereof are omitted. Differences from the flowchart shown in FIG. 9 will be described hereinafter.

The receiving unit 620 determines whether the user has operated the pointer as the first input (Step S610), and when it determines that the first input has been entered, the process proceeds to the next step S620.

The specifying unit 630 acquires the position of the pointer at the time when the receiving unit 620 received the first input (Step S620).

The specifying unit 630 specifies, from among a plurality of feature points calculated by the calculation unit 310, the position of the feature point that is located on the extension line of the moving direction and closest to the current position of the pointer (the position acquired in the step S620) as the first position (Step S630). That is, the specifying unit 630 searches for the feature point calculated by the calculation unit 310 along the moving direction of the pointer by using the current position of the pointer (the position acquired in the step S620) as the starting point of the search. Then, the specifying unit 630 specifies the position of a feature point that has been searched for and is closest to the current position of the pointer as the first position.

After the step S630, the display control unit 340 moves the pointer to the first position specified in the step S630 (Step S270), and the flow is finished.

### Explanation of Effect

In the sixth example embodiment, the moving direction of the pointer is received as the first input, and the first input is used to specify the first position. Therefore, it is possible to enable the user to specify the feature point that he/she wants to designate by a more intuitive operation, so that the operability is improved.

### Seventh Example Embodiment

Next, a seventh example embodiment will be described. The seventh example embodiment differs from the above-described example embodiments in that the display control unit further displays a visual area, which is a window in which the pointer and an image around the pointer are displayed in an enlarged manner. Differences from the other example embodiments will be described hereinafter in a concrete manner, and redundant descriptions will be omitted as appropriate.

### Explanation of Configuration

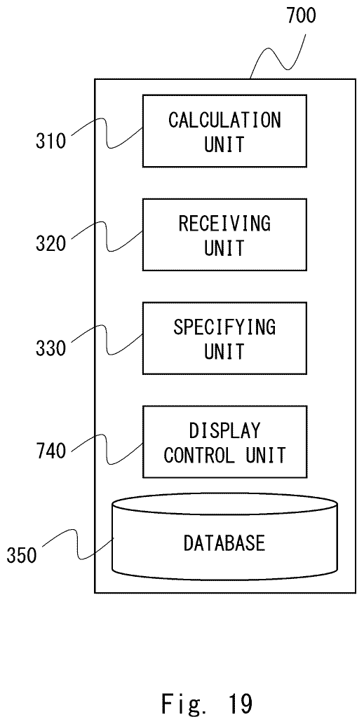

FIG. 19 is a block diagram showing an example of a configuration of an input support system according to the seventh example embodiment. As shown in FIG. 19, the input support system 700 includes a calculation unit 310, a receiving unit 320, a specifying unit 330, a display control unit 740, and a database 350.

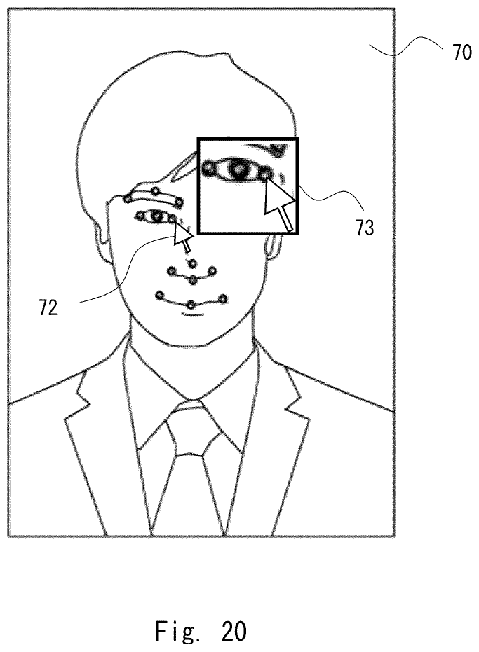

The display control unit 740 performs display control similar to that performed by the display control unit according to the other example embodiments described above. However, the display control unit 740 differs from the display control unit according to the other example embodiments described above in that it displays, after the pointer is moved to the first position or the second position, a visual area in which the pointer and an image around the pointer are displayed in an enlarged manner. The visual area is, for example, a window displayed around the pointer, such as at the upper right of the pointer 72 as shown in FIG. 20, and is an area 73 framed by a rectangular box. The area 73 is displayed over an input image 70 in a superimposed manner. The user can designate a feature point more accurately by operating the pointer while viewing the enlarged image displayed in the area 73. Further, the display control unit 740 may display the visual area when the position of the pointer is within a predetermined range from the position of the feature point calculated by the calculation unit 310. For example, it may be configured so that the visual area is displayed when the pointer is within several pixels from the position of the calculated feature point. In this way, it is possible to display the visual area even when the user moves the pointer to the feature point by himself/herself without entering the first input or the second input.

Further, when the pointer is located in the predetermined range from the feature point calculated by the calculation unit 310, the display control unit 740 may lower the sensitivity of the pointer to a value that is lower than the sensitivity of the pointer when the pointer is located outside the predetermined range from the feature point. The sensitivity of the pointer is the ratio of the amount of movement of the pointer to the amount of movement of the operation performed by the user. That is, lowering the sensitivity of the pointer means reducing the ratio of the amount of movement of the pointer to the amount of movement of the operation performed by the user. By lowering the sensitivity of the pointer, the accuracy of the operation that the user performs to move the pointer is improved, thus making it possible to accurately designate a feature point.

### Explanation of Operation

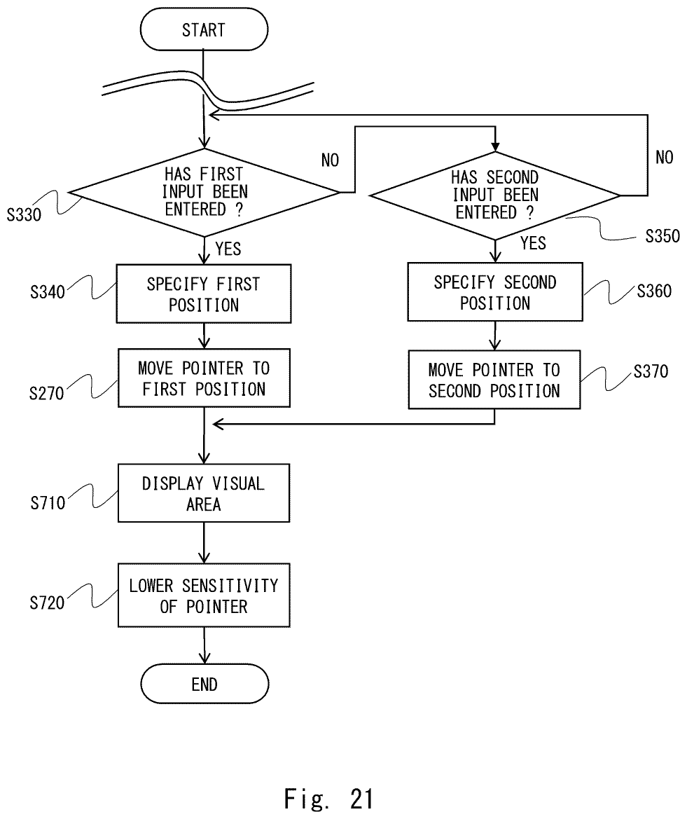

Next, operations performed by the input support system 700 according to the seventh example embodiment will be described with reference to FIG. 21. FIG. 21 is a flowchart showing an example of operations performed by the input support system 700 according to the seventh example embodiment. As shown in FIG. 21, the display control unit 740 differs from the display control unit 340 in that the display control unit 740 performs a process for displaying a visual area in a step S710 and a process for changing the sensitivity of the pointer in a step S720 in addition to the operations performed by the display control unit 340, and the rest of the processes are similar to those shown in FIG. 9. Differences from the flowchart shown in FIG. 9 will be described hereinafter.

After moving the pointer to the first position in the step S270, the display control unit 740 displays a visual area in which the pointer and an image around the pointer are displayed in an enlarged manner at the upper right of the pointer (Step S710). The timing at which the display control unit 740 displays the visual area may be any timing as long as the position of the pointer and the position of the feature point calculated by the calculation unit 310 are within the predetermined distance. Therefore, for example, the visual area may be displayed after the pointer is displayed at the second position in the step S370. As described above, when the position of the pointer and the calculated position related to the feature point are within the predetermined distance, the display control unit 740 displays an enlarged image of a partial image of the input image over the input image in a superimposed manner, the partial image showing an area around the pointer.

When the pointer is located in the predetermined range from the feature point calculated by the calculation unit 310 after moving the pointer to the first position or the second position, the display control unit 740 lowers the sensitivity of the pointer to a value that is lower than the sensitivity of the pointer when the pointer is located outside the predetermined range from the feature point (Step S720).

### Explanation of Effect

In the seventh example embodiment, when the position of the pointer and the calculated position of the feature point are within the predetermined distance, the display control unit displays the visual area. In this way, the user can designate a feature point more accurately because he/she can designate it while checking the image in which the pointer and an area therearound are enlarged.

Although the present invention has been described with reference to example embodiments, the present invention is not limited by the above-described example embodiments. Various modifications that can be understood by those skilled in the art can be made to the configuration and details of the present invention within the scope of the invention. Further, the example embodiments can be combined with one another.

The whole or part of the example embodiments disclosed above can be described as, but not limited to, the following supplementary notes.

### Supplementary Note 1

An input support system comprising:
calculation means for calculating a position related to a feature point from an input image;
display control means for displaying the input image and a pointer operated by a user on a screen;
receiving means for receiving a first input from the user; and
specifying means for specifying a first position based on the position related to the feature point calculated by the calculation means, wherein
the display control means moves the pointer to the first position in response to receiving the first input.

### Supplementary Note 2

The input support system described in Supplementary note 1, wherein the specifying means specifies the first position based also on an order in which the user inputs positions related to feature points.

### Supplementary Note 3

The input support system described in Supplementary note 2, wherein the calculation means further calculates the order based on the input image.

### Supplementary Note 4

The input support system described in Supplementary note 1, wherein the specifying means specifies the first position based on the position of the pointer and the position related to the feature point.

### Supplementary Note 5

The input support system described in Supplementary note 1, wherein the specifying means specifies the first position based on the position of the pointer at the time the first input was received, a moving direction of the pointer, and the position related to the feature point.

### Supplementary Note 6

The input support system described in Supplementary note 1, wherein
the specifying means specifies a new first position and further specifies a second position,
the second position is the first position specified before the new first position, and
the display control means moves, upon receiving a second input from the user, the pointer to the second position.

### Supplementary Note 7

The input support system described in Supplementary note 6, wherein the specifying means specifies the first position according to the order in which the user inputs positions related to feature points, and specifies the first position immediately preceding the new first position as the second position according to an order that is the reverse of the order used for specifying the first positions.

### Supplementary Note 8

The input support system described in Supplementary note 1, wherein the specifying means specifies the first position based on, among the feature points of which the positions have been calculated by the calculation means, a feature point of which the position has not yet been designated by the user in an area within a predetermined distance from the feature point.

### Supplementary Note 9

The input support system described in Supplementary note 1, wherein the specifying means calculates, for each of the feature points of which the positions are calculated by the calculation means, an estimated value of a difference between a position calculated by the calculation means and a position designated by the user, and specifies the first position based on, among the feature points of which the positions are calculated by the calculation means, a feature point of which the estimated value is equal to or larger than a predetermined value.

### Supplementary Note 10

The input support system described in any one of Supplementary notes 1 to 9, further comprising warning means for issuing a warning in a case where the position related to the feature point calculated by the calculation means and the position related to the feature point input by the user are away from each other by distance

### Supplementary Note 11

The input support system described in any one of Supplementary notes 1 to 10, wherein the position related to the feature point is a position of a feature point.

### Supplementary Note 12

The input support system described in any one of Supplementary notes 1 to 10, wherein the position related to the feature point is a position of a bounding box surrounding a feature point constituting an object.

### Supplementary Note 13

The input support system described in Supplementary note 11, wherein the display control means further displays the position of the feature point.

### Supplementary Note 14

The input support system described in Supplementary note 12, wherein the display control means further displays the bounding box.

### Supplementary Note 15

The input support system described in any one of Supplementary notes 1 to 14, wherein in a case where the position of the pointer and the position related to the feature point are within a predetermined distance, the display control means displays an enlarged image of a partial image of the input image over the input image in a superimposed manner, the partial image showing an area around the pointer.

### Supplementary Note 16

An input support method, wherein a computer:
calculates a position related to a feature point from an input image;
displays the input image and a pointer operated by a user on a screen;
receives a first input from the user;
specifies a first position based on the calculated position related to the feature point; and
moves the pointer to the first position in response to receiving the first input.

### Supplementary Note 17

A non-transitory computer readable medium storing a program for causing a computer to perform:
a calculation step of calculating a position related to a feature point from an input image;
a display control step of displaying the input image and a pointer operated by a user on a screen;
a receiving step of receiving a first input from the user; and
a specifying step of specifying a first position based on the position related to the feature point calculated in the calculation step, wherein
in the display control step, the pointer is moved to the first position in response to receiving the first input.

### REFERENCE SIGNS LIST

20, 30, 40, 70 IMAGE
21, 31a, 31b FEATURE POINT
22, 32, 42, 72 POINTER
41, 43a, 43b BOUNDING BOX
41a, 41b VERTEX
73 AREA
100, 200, 300, 400, 500, 600, 700 INPUT SUPPORT SYSTEM
110, 210, 310, 410 CALCULATION UNIT
120, 220, 320, 520, 620 RECEIVING UNIT
130, 230, 330, 430, 630 SPECIFYING UNIT
140, 240, 340, 440, 540, 740 DISPLAY CONTROL UNIT
201 OUTPUT DEVICE
202 INPUT DEVICE
203 STORAGE DEVICE
204 MEMORY
205 PROCESSOR
250, 350 DATABASE
560 WARNING UNIT

What is claimed is:

1. An input support system comprising:
at least one memory storing instructions; and
at least one processor configured to execute the instructions to:
calculate a position related to a feature point from an input image;
display the input image and a pointer operated by a user on a screen;
receive a first input from the user;
specify a first position based on the calculated position related to the feature point; and
move the pointer to the first position in response to receiving the first input.

2. The input support system according to claim 1, wherein the processor is further configured to execute the instructions to specify the first position based also on an order in which the user inputs positions related to feature points.

3. The input support system according to claim 2, wherein the processor is further configured to execute the instructions to further calculate the order based on the input image.

4. The input support system according to claim 1, wherein the processor is further configured to execute the instructions to specify the first position based on the position of the pointer and the position related to the feature point.

5. The input support system according to claim 1, wherein the processor is further configured to execute the instructions to specify the first position based on the position of the pointer at the time the first input was received, a moving direction of the pointer, and the position related to the feature point.

6. The input support system according to claim 1, wherein the processor is further configured to execute the instructions to:
specify a new first position and further specifies a second position, the second position being the first position specified before the new first position, and
move, upon receiving a second input from the user, the pointer to the second position.

7. The input support system according to claim 6, wherein the processor is further configured to execute the instructions to specify the first position according to the order in which the user inputs positions related to feature points, and specify the first position immediately preceding the new first position as the second position according to an order that is the reverse of the order used for specifying the first positions.

8. The input support system according to claim 1, wherein the processor is further configured to execute the instructions to specify the first position based on, among the feature points of which the positions have been calculated, a feature point of which the position has not yet been designated by the user in an area within a predetermined distance from the feature point.

9. The input support system according to claim 1, wherein the processor is further configured to execute the instructions to calculate, for each of the feature points of which the positions are calculated, an estimated value of a difference between a calculated position and a position designated by the user, and specify the first position based on, among the feature points of which the positions are calculated, a feature point of which the estimated value is equal to or larger than a predetermined value.

10. The input support system according to claim 1, wherein the processor is further configured to execute the instructions to issue a warning in a case where the calculated position to the feature point and the position related to the feature point input by the user are away from each other by a predetermined distance or longer.

11. The input support system according to claim 1, wherein the position related to the feature point is a position of a feature point.

12. The input support system according to claim 1, wherein the position related to the feature point is a position of a bounding box surrounding a feature point constituting an object.

13. The input support system according to claim 11, wherein the processor is further configured to execute the instructions to further display the position of the feature point.

14. The input support system according to claim 12, wherein the processor is further configured to execute the instructions to further display the bounding box.

15. The input support system according to claim 1, wherein the processor is further configured to execute the instructions to, in a case where the position of the pointer and the position related to the feature point are within a predetermined distance, display an enlarged image of a partial image of the input image over the input image in a superimposed manner, the partial image showing an area around the pointer.

16. An input support method, wherein a computer:
calculates a position related to a feature point from an input image;
displays the input image and a pointer operated by a user on a screen;
receives a first input from the user;
specifies a first position based on the calculated position related to the feature point; and
moves the pointer to the first position in response to receiving the first input.

17. A non-transitory computer readable medium storing a program for causing a computer to perform:
a calculation step of calculating a position related to a feature point from an input image;
a display control step of displaying the input image and a pointer operated by a user on a screen;
a receiving step of receiving a first input from the user; and
a specifying step of specifying a first position based on the position related to the feature point calculated in the calculation step, wherein
in the display control step, the pointer is moved to the first position in response to receiving the first input.
